(19) United States
(12) Patent Application Publication
(10) Pub. No.: US 2011/0037983 A1
(43) Pub. Date: Feb. 17, 2011

(54) Optical Component and Wear Sensor

(75) Inventor: Brian Davies, Western Australia (AU)

Correspondence Address: THE WEBB LAW FIRM, P.C., 700 KOPPERS BUILDING, 436 SEVENTH AVENUE, PITTSBURGH, PA, 15219, US

(73) Assignee: BRIAN INVESTMENTS PTY LTD, Esperance, Western Australia (AU)

(21) Appl. No.: 12/746,233

(22) PCT Filed: Dec. 4, 2008
(86) PCT No.: PCT/AU2008/001799

§ 371 Date: Sep. 20, 2010

(30) Foreign Application Priority Data
Dec. 4, 2007 (AU) 2007906615
Sep. 30, 2008 (AU) 2008905091
Oct. 21, 2008 (AU) 2008905440

(51) Int. Cl. G01N 21/55

(52) U.S. Cl. 356/445

(57) ABSTRACT

A wear measuring device comprises a body having a wearable portion at the first end, a light conductive region internal to the body and the light conductive region has a reflective portion within the wearable portion. The reflective portion is configured to reflect light directed through the light conductive portion and at the reflective portion back down the light conductive portion. One or more characteristics of light reflected by the reflective portion are related to the extent of wear to the wearable portion. An optical component comprises a longitudinal axis and a plurality of reflective elements spaced along said longitudinal axis. The reflective elements are arranged to reflect light directed in a direction substantially aligned with said longitudinal axis. The magnitude of the reflectance is a function of physical degradation, ablation or wear of the component in a direction along the length of the component.

### FIELD OF THE INVENTION

The present invention relates to an optical component and a wear sensor. The optical component can non-exclusively be used in a device for measuring wear. Particularly, though not exclusively, the device is for measuring in-situ wear on a wear plate.

### BACKGROUND OF THE INVENTION

Plates of hardened material are often used to minimise the effect of wear on structural elements of a piece of equipment. The material of the wear plate is selected for resistance to wear. The wear plates act as a sacrificial element so that plates are worn rather than the structural element of the equipment.

Difficulties arise when monitoring and determining the extent of wear of the wear plates because, for example, the plates are located in positions that are difficult to access. As a consequence, it is difficult to determine the exact timing of a wear plate change-out because it is desirable to use the wear plate to the maximum extent of its life, but not to the extent of failure. There is therefore a need for a wear sensor for use with systems subject to wear.

Wear also occurs to other mechanical components, particularly those which operate in harsh conditions. It is often impossible to determine the extent of wear to some components prior to component failure or disassembly/inspection during a shutdown.

Various devices for measuring the amount of wear that a system has been subjected to have been described in the Applicant's prior applications, for example WO 2006/081610 and WO 2007/128068.

It will be clearly understood that, although prior art use and publications are referred to herein, this reference does not constitute an admission that any of these form a part of the common general knowledge in the art, in Australia or in any other country.

### SUMMARY OF THE INVENTION

In the statement of invention and description of the invention which follow, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

According to a first aspect of the present invention, there is provided a device for measuring wear said device comprising:
a body having a wearable portion at a first end; and,
a light conductive region of the body,
wherein the light conductive region has a reflective portion within the wearable portion,
wherein the reflective portion is configured to reflect light directed through the light conductive portion and at the reflective portion back down the light conductive portion, wherein one or more characteristics of light reflected by the reflective portion is related to the extent of wear to the wearable portion.

In one embodiment one of the characteristics is the amount of reflected light.

In one embodiment the device comprises a light source for emitting light directed so as to travel through the light conductive portion toward said reflective portion.

In an embodiment said device comprises a detector for measuring the amount of reflected light.

In a further embodiment the reflective portion comprises a taper which narrows towards the first end of said body.

In yet a further embodiment the body is in the form of a fastener. In another embodiment, the body is in the form of a probe.

In a further embodiment the body further comprises an external thread so as to be securable within an aperture of a wear plate of a wear plate system.

In an embodiment the reflective portion is formed of one or more reflective elements which are ablated as the wearable portion is worn, such that ablation of the one or more reflective elements reduces the amount of reflection of the reflective portion.

In another embodiment the one or more reflective portion comprises a conically-shaped metallic surface.

In an embodiment the light conductive region comprises an optical component.

In an embodiment the optical component comprises the one or more reflective elements.

In an embodiment the one or more reflective elements are arranged to extend at least partly axially about a longitudinal axis of the body.

In an embodiment the one or more reflective elements are arranged to extend arcuately about a length of the body.

In an embodiment the one or more reflective elements comprise a plurality of faces extending in a spaced relationship along a length of the body, wherein two or more of the reflective elements together form a composite reflective area when the body is viewed from a second end opposite the first end.

In an embodiment the one or more reflective elements are each longitudinally spaced apart and have a hole or void of differing dimension.

In an embodiment the one or more reflective elements each form at least a partial boundary of the reflective portion.

In an embodiment an aperture in the reflective portion dilates as a length of the reflective portion is removed so that the reflective area correspondingly decreases.

In an embodiment the reflective elements are longitudinally and transversely spaced apart relative to a longitudinal axis of the body.

In an embodiment the reflective elements contrast with relatively less reflective elements.

In an embodiment the relatively less reflective elements are marks and the reflective elements are spaces between the marks.

In an embodiment the one or more characteristics comprise or are related to the number of reflective elements remaining in the reflective portion.

In an embodiment the reflective portion comprises a plurality of markings spaced along and across a length of the wearable portion so that each marking is visible from a second end of the body, the markings being arranged so as to be successively worn away as a length of the wearable portion is worn away with wear to the object.

According to a second aspect of the present invention, there is provided a wear sensor comprising:
a light source;
a light receiver configured to measure incident light;
a body having a wearable portion at a first end; and
a light conductive region within the body, wherein said light source is arranged to project light into the light conductive region and said light receiver is arranged to receive light from the light conductive region, wherein the light conductive region has a reflective portion within the wearable portion, wherein the reflective portion is configured to reflect light from the light source towards the light receiver; and,
wherein light reflected by the reflective portion and then received by said light receiver is related to the extent of wear to the wearable portion.

According to a third aspect of the present invention there is provided a method of measuring the amount of wear a wear sensor has been subjected to, the method comprising:
directing light into an optically transmissible body of a wear sensor, the body comprising a reflective portion configured to reflect light directed through the light conductive portion and at the reflective portion back down the light conductive portion;
measuring one or more characteristics of light reflected by the reflective portion.

According to a fourth aspect of the present invention there is provided a method of determining the amount of wear a wear sensor has been subjected to, the method comprising:
calculating the amount of wear based on the measured one or more characteristics of the above method.

According to a fifth aspect of the present invention there is provided an optical component comprising:
a longitudinal axis; and,
a plurality of reflective elements spaced along said longitudinal axis,
wherein the reflective elements are arranged to reflect light directed in a direction substantially aligned with said longitudinal axis,
wherein the magnitude of the reflectance is a function of physical degradation or wear of the component in a direction along the length of the component.

In an embodiment, the reflective elements comprises multiple pie, wedge, acuate, circular, triangular, frustoconical or frusto-pyramidal segments.

In an embodiment, the reflective elements are spaced regularly along the longitudinal axis.

In an embodiment each reflective element extends substantially radially from the longitudinal axis.

In an embodiment, the reflective elements are positioned helically around the longitudinal axis.

In an embodiment each reflective element extends substantially axially about the longitudinal axis.

In an embodiment, the optical component is formed of an optically conductive material within which the reflective elements are positioned.

In accordance with a sixth aspect of the present invention there is provided a method of measuring the amount of wear caused to an object, the method comprising:
providing an optical component in the object, wherein the optical component has a reflective portion which reflects light directed to a first end of the component in a manner which is affected by the extent of wear to the optical component;
directing light into a first end of the optical component; and,
measuring the amount of light reflected from the reflective portion of the optical component, where the amount of reflected light is a function of the length of the optical component.

In an embodiment the optical component is as defined above.

In accordance with a seventh aspect of the present invention there is provided a wear sensor for measuring the amount of wear of an object, the wear sensor comprising:
an optically transmissible elongate body which in use is disposed inside the object, the elongate body comprising a plurality of markings spaced along and across a length of the elongate body so that each marking is visible from an end of the elongate body, the markings being arranged so as to be successively worn away as a length of the elongate body is worn away with wear to the object;
wherein the number of remaining markings provides an indication of the amount of wear that the object has been subjected to.

The wear sensor may comprise a device for assessing the number of remaining markings. A portion of the elongate body may be generally tapered. The markings may be spaced along the generally tapered portion of the elongate body.

The wear sensor may comprise a contrasting background to the markings. The contrasting background may comprise an opaque backing on the markings.

The device for assessing the number of remaining markings may be configured to pass a light over the markings and count the number of remaining markings.

In accordance with an eighth aspect of the present invention, there is provided a method of determining the amount of wear a wear sensor has been subjected to, the method comprising:
directing light into an optically transmissible elongate body of a wear sensor, the elongate body comprising a plurality of markings spaced along and across a length of the elongate body so that each marking is visible from an end of the elongate body, the markings being arranged so as to be successively worn away as a length of the elongate body is worn away; and
assessing the number of remaining markings;
wherein the number of remaining markings provides an indication of the amount of wear the wear sensor has been subjected to.

In an embodiment, assessing the number of markings comprises counting the number of remaining markings.

According to a ninth aspect of the present invention there is provided an optical component for reflecting light entering an end thereof comprising:
an optically transmissible elongate body comprising reflective elements positioned along a longitudinal axis of the elongate body, each reflective element being arranged to extend at least partially axially about a longitudinal axis of the elongate body;
wherein the amount of reflected light varies as a length of the elongate body is removed.

The reflective elements may be concentric. At least one reflective element may be in the general shape of a polygon or one or more parts of the shape of a polygon. A portion of the elongate body may be generally tapered.

The elongate body may have a set of steps with at least one reflective element being positioned on a part of a respective step that can be seen from the end.

The optical component may comprise an opaque portion, the opaque portion being positioned at least partly on an opposite side of the reflective elements relative to the end. The opaque portion may cover a part of the elongate body.

In accordance with a tenth aspect of the present invention there is provided an optical component for reflecting light entering an end thereof comprising:
an optically transmissible elongate body comprising reflective elements positioned along a longitudinal axis of the elongate body, each reflective element being arranged to extend arcuately about the elongate body;
wherein the amount of reflected light varies as a length of the elongate body is worn away.

In accordance with a eleventh aspect of the present invention there is provided an optical component for reflecting light entering an end thereof comprising:
an optically transmissible elongate body comprising reflective elements positioned along a longitudinal axis of the elongate body, each reflective element forming at least a partial boundary about the elongate body;
wherein the amount of reflected light varies as a length of the elongate body is removed.

In accordance with a twelfth aspect of the present invention there is provided an optical component for reflecting light entering an end thereof comprising:
an optically transmissible elongate body comprising reflective elements positioned along a longitudinal axis of the elongate body, each reflective element comprising a face extending in a spaced relationship along a longitudinal axis of the elongate body, the reflective elements together forming a composite reflective area when the elongate body is viewed from the end;
wherein an aperture in the composite reflective area dilates as a length of the elongate body is removed so that the reflective area correspondingly decreases.

In an embodiment the aperture is created after a first amount of the elongate body is removed.

In accordance with a fourteenth aspect of the present invention there is provided a composite reflector comprising longitudinally spaced hollowed reflective elements of differing diameter, where progressive removal of the reflective elements causes the composite reflector to vary in reflectance.

The hollowed reflective elements may be non-overlapping. The diameter of the hollow of one element may be substantially the same as an outer diameter of an adjacent element.

According to a fifteenth aspect of the present invention, there is provided a wear sensor system comprising:
one or more wear sensors as defined above installed in one or more items subjected to wear;
a monitor for reading the one or more characteristics of the reflected light; and,
an output for producing information related to the wear of the one or more items based on the reading of the one or more characteristics.

In an embodiment the output comprises an alert generator for issuing an alert when the one or more sensors indicate wear has reached a threshold.

In an embodiment the output comprises a display for showing the measured wear of one or more of the sensors.

In an embodiment the displayed measured wear is in the form of the remaining thickness of the one or more items.

According to a sixteenth aspect of the present invention, there is provided a method comprising:
providing one or more wear sensors as defined above;
reading the one or more characteristics of the reflected light when the or each sensor is installed in one or more items subjected to wear; and,
outputting information related to the wear of the one or more items based on the reading of the one or more characteristics.

### BRIEF DESCRIPTION OF THE DRAWINGS

In order to provide a better understanding, embodiments of the present invention will now the described, by way of example only, with reference to the accompanying drawings, in which:

FIG. 1A is a cross-sectional elevation of a first embodiment of a device of the present invention prior to wear;

FIG. 1B is a cross-sectional side elevation of the device in FIG. 1A having been subjected to wear;

FIG. 2 is a schematic representation of a wear plate system attached to a piece of equipment showing varying wear over the surface of the wear plate system and an embodiment of a monitoring system according to an embodiment to the present invention;

FIG. 3A is a partial cross-sectional side elevation of a further embodiment of a device of the present invention prior to wear;

FIG. 3B is a cross-sectional side elevation of the device shown in FIG. 3A having been subjected to wear;

FIG. 3C is a partial cross-sectional side elevation of a further embodiment of a device of the present invention prior to wear;

FIG. 3D is a cross-sectional side elevation of the device shown in FIG. 3C having been subjected to wear;

FIG. 4A shows a cross-sectional side elevation of another embodiment of a device of the present invention prior to wear;

FIG. 4B shows a cross-sectional side elevation of the device shown in FIG. 4A having been subjected to wear;

FIG. 5A shows a side elevation view of an embodiment of an optical component of the present invention;

FIG. 5B shows an end view of the embodiment of the optical component shown in FIG. 6A;

FIG. 6A shows a side elevation view of a further embodiment of an optical component of the present invention;

FIG. 6B shows an end view of the embodiment of the optical component shown in FIG. 6A;

FIG. 7A shows a side view of an optical component in accordance with an embodiment of the present invention;

FIG. 7B shows a side view of an optical component in accordance with another embodiment of the present invention;

FIG. 8A shows an end view of the optical component shown in FIG. 7A;

FIG. 8B shows a cross-sectional view through cross-section A-A of the optical component shown in FIG. 8A;

FIG. 8C shows a cross-sectional view through cross-section A-A of the optical component shown in FIG. 8B having been subjected to wear;

FIG. 8D shows a partial cross-sectional view of the optical component through the segment Z-Z shown in FIG. 8A;

FIG. 9A is a cross-sectional side elevation of a further embodiment of a device including an optical component of the present invention prior to wear;

FIG. 9B is a cross-sectional side elevation of the device and optical component shown in FIG. 9A having been subjected to wear;

FIG. 10 shows a side view of an embodiment of an optical component of a wear sensor of the present invention;

FIG. 11 shows a front view of the optical component shown in FIG. 10;

FIG. 12A shows a side view of an embodiment of an optical component of a wear sensor of the present invention;

FIG. 12B shows a front view of the optical component shown in FIG. 12A;

FIG. 13A shows a side cross sectional view of an embodiment of a wear sensor of the present invention;

FIG. 13B shows a front view of the wear sensor shown in FIG. 13A;

FIG. 14 shows an end view of the wear sensor shown in FIG. 13A;

FIG. 15 shows a front cross-sectional view of a further embodiment of a wear sensor of the present invention;

FIG. 16 shows a side view of the wear sensor shown in FIG. 15;

FIG. 17A shows a partial cross-sectional side elevation of the wear sensor of FIG. 16 installed for use prior to wear; and

FIG. 17B shows a cross sectional side elevation of the wear sensor shown on FIG. 17A having been subjected to wear.

### DETAILED DESCRIPTION OF EMBODIMENTS OF THE INVENTION

The present invention relates generally to an optical component and a wear measuring device. The optical component has particular application in some embodiments of the device, however it is not intended to be exclusively used in the device and may find other applications. The device comprises a body having a wearable portion at a first end, a light conductive region internal to the body and the light conductive region has a reflective portion within the wearable portion. The reflective portion is configured to reflect light directed through the light conductive portion and at the reflective portion back down the light conductive portion. One or more characteristics of light reflected by the reflective portion are related to the extent of wear to the wearable portion. Further embodiments are described below.

The optical component comprises a longitudinal axis and a plurality of reflective elements spaced along said longitudinal axis. The reflective elements are arranged to reflect light directed in a direction substantially aligned with said longitudinal axis. The magnitude of the reflectance is a function of physical degradation, ablation or wear of the component in a direction along the length of the component. Further embodiments are described below.

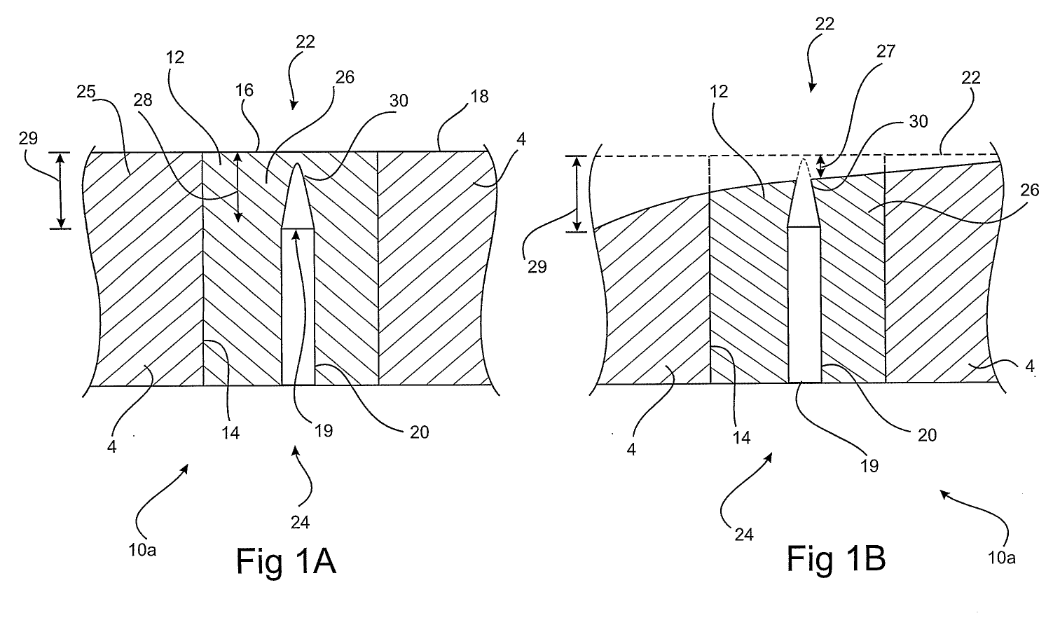

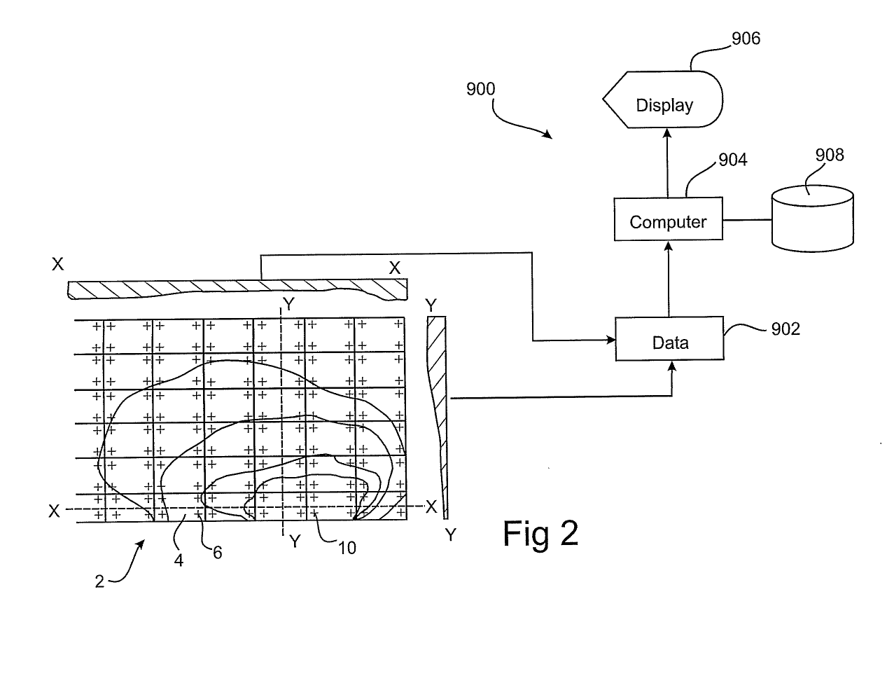

FIG. 1A shows a device 10a for measuring wear according to one embodiment of the present invention. The device 10a comprises a body 12 configured to extend through an aperture 14 in an object subject to wear, such as for example, a wear plate 4 of a wear plate system 2 (shown in FIG. 2). The body 12 comprises a wearable portion 26 having a depth 28 that extends from a first end 22 towards a second end 24 of the body 12. The body 12 comprises a surface 16 (FIG. 1A) which, in the current embodiment, may be co-planar with surface 18 of the wear plate 4. In use the surface 16 is subject to wear. The wearable portion 26 defines an amount of the body which can be worn away while the body is still useful. Preferably the depth 28 coincides with or is more than a depth 29 of wear acceptable to the wear plate 4. The amount of wear into the body 12 in a direction extending from the first end 22 to the second end 24 defines a depth 27 of wear into surface 16 when the wearable portion 26 is worn.

The device 10a further comprises a light conductive region 20 internal of the body 10a extending from the second end 24 to the first end 22 and configured to be capable of conducting light therethrough. A reflective portion 19 is located within the light conductive region 20 and configured so as to reflect light towards the second end 24 of the body 12. For the embodiment shown, the reflective portion 19 fits substantially within the light conductive region 20. The amount of light reflected from the reflective portion 19 is substantially proportional to the depth of wear 27 as the wearable portion 26 is worn. For the current embodiment shown, the reflective portion 19 has a tapered portion 30 which narrows toward the first end 22 of the body 12.

FIG. 1B shows the embodiment of the device 10 shown in FIG. 1A once wear has occurred. A portion of the wear plate 4 has been worn away as indicated by the depth 27. As the wearable portion 26 becomes progressively worn, the wear affects the reflective portion 19. In particular, as the depth of wear to the worn surface 29 increases due to further wearing to the wear plate 4, the light conductive region 20 and the reflective portion 19 wears also. The tapered portion 30 is configured so that the internal region 20 may become exposed after a certain amount of wear has occurred to the wear plate 4, or it may commence at surface 16. As the wearable depth 28 increases, the amount of light reflected by the reflective portion 19 begins to change and is thus proportional, or a function of, the depth of wear. It may be appreciated that the tapered portion 30 may comprise any linear or non-linear shape that may alter the reflectivity of the reflective portion 19 as a function of the depth 28.

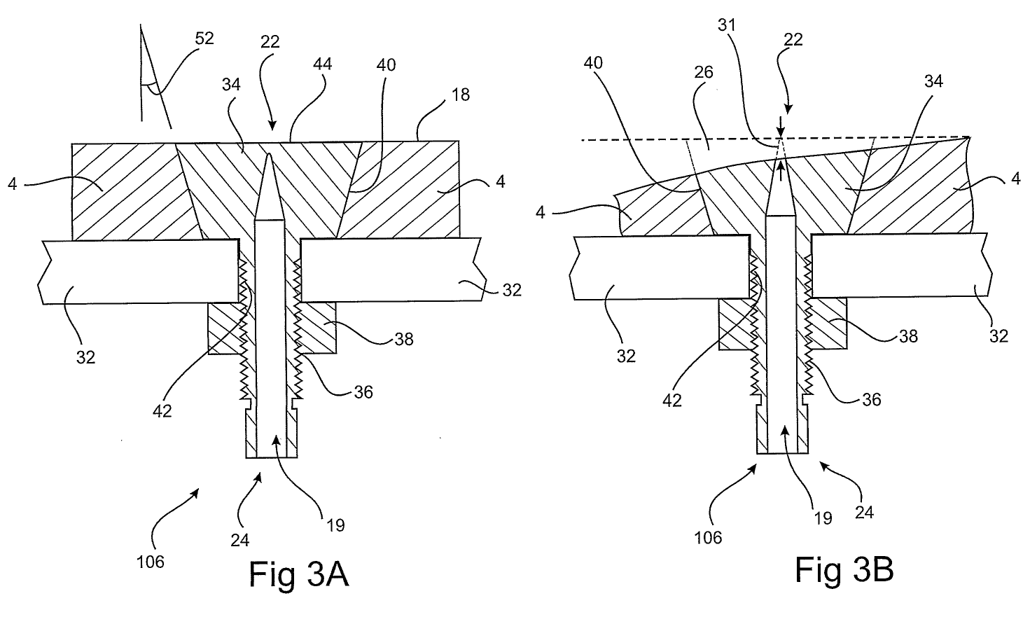

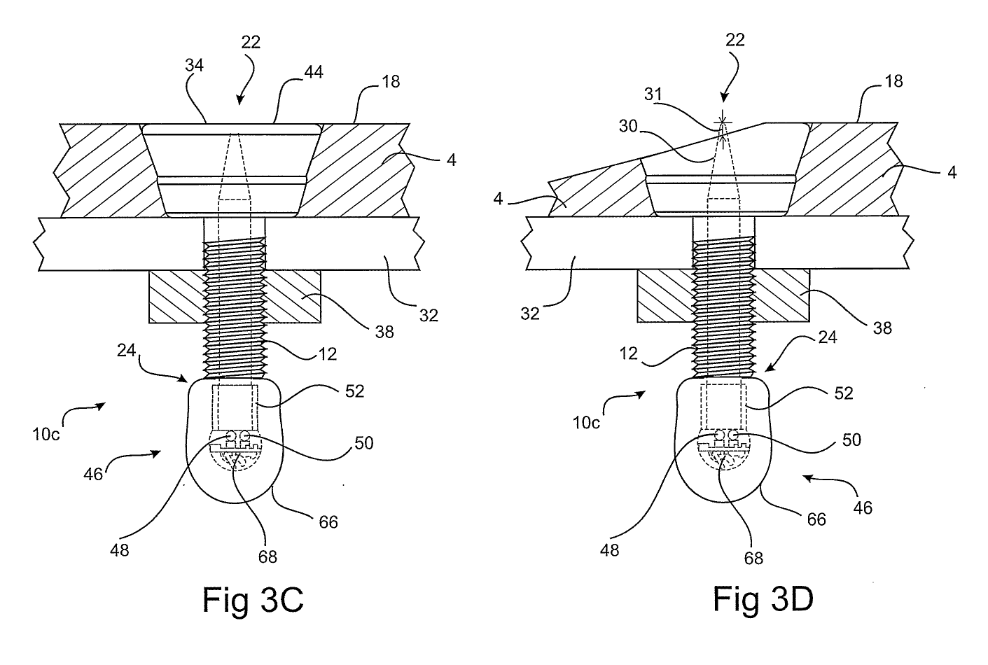

For the current embodiment, the body 12 is a separate component to the wear plate 4 and is inserted or threaded into an aperture 14. However, it is envisaged that the body 12, in a further embodiment, may be integrally formed within the wear plate 4. Furthermore, the body 12 may take the form of a fastener, as shown, for example, in FIGS. 3 to 5.

With reference to FIGS. 3A and 3B, there is shown a cross-section of a further embodiment of a device 10b incorporated into a fastener for holding the wear plate 4 to a structural element 32. The device 10b comprises a fastener having a body 12 (in the form of a bolt), having a head 34 and a shank 36. The shank 36 may have an external thread for receiving a retaining nut 38 (shown in FIGS. 3A and 3B). The head 34 sits in a complementary frusto-conical hole 40 in the plate 4. The shank 36 passes through a hole 42 in the structural element 32. The head 34 and retaining nut 38 co-operatively fasten the wear plate 4 to the structural element 32. This type of fastener is described in PCT international application No. PCT/AU2005/001820. It may be appreciated that a retaining nut 38 may be unnecessary if the fastener is merely inserted into a hole 40 for the purpose of monitoring the wear and not required to perform a structural purpose.

In the current embodiment the hole 40 has a half-opening angle 52 of about 5 to 20° and the head 34 is of, but is not limited to, a complementary shape. It will be appreciated that other fasteners known in the art could be used, including traditional bolts. In the current embodiment, the top surface 44 of the head 34 remains co-planar with the outer surface 18 of the wear plate 4 (as with the previous embodiment). The device 10b is configured with a light conductive region 20 within the shank 36 and extends from the second end 24 substantially to the surface 44 (FIG. 3A) at the first end 22 of the body 12.

The current embodiment of the device 10b is shown in FIG. 3B with the wearable portion 26 having been worn down to a depth 31, in accordance with wear experienced by the adjacent wear plate 4.

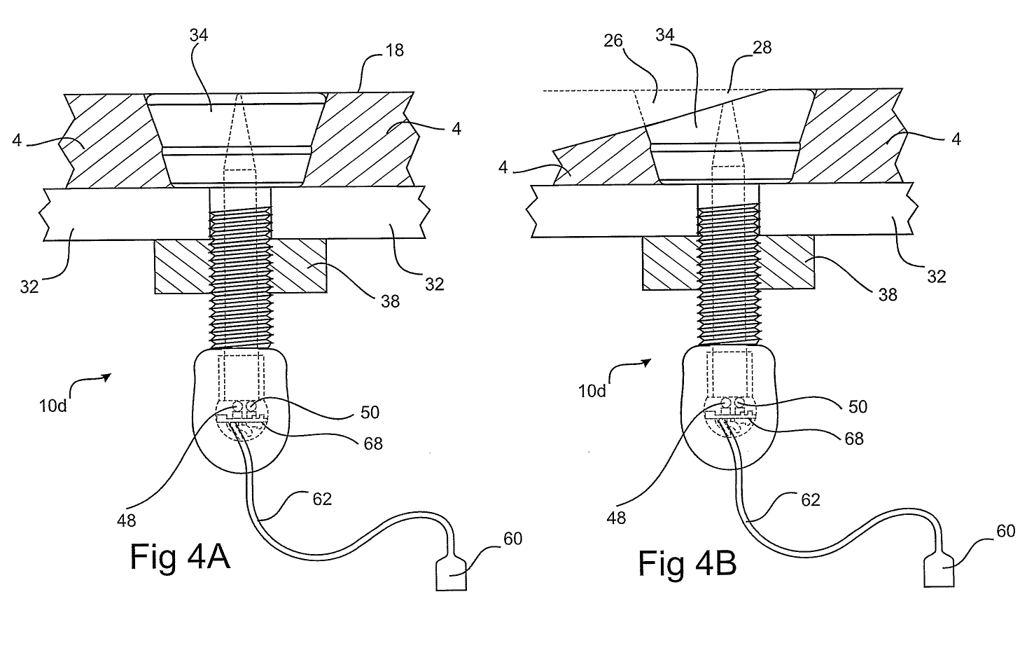

FIGS. 3C and 3D show a device 10c in accordance with a further embodiment of the present invention. The device 10c further comprises a wear measuring unit (WMU) 46. The WMU 46 comprises a light sensor 48 and a light source 50. The light source 50 may, for example, be an infrared light emitter, such as an IR LED. This light sensor 48 may be an IR photodiode or IR phototransistor. The WMU 48 is fastened to the second end of the shank 24, for example, using a resilient ring situated ion a groove of the shank in use. When operated, the light source 50 generates light that is propagated through the reflective portion 19 towards the first end 22 of the body 12. The reflective portion 19 is configured so as to reflect the light back towards the second end 24 of the body 12 where the light is received by the light sensor 48. When no wear has occurred (as shown in FIG. 4A), the reflected light will be substantially the same as that emitted by the light source 50. As the wearable portion 26 is worn, and the depth 31 of wear develops, and increases (as shown in FIG. 3D), the tapered portion 30 will begin to be worn also, physically altering the reflective portion 19. As a result, the light reflected back to the light sensor 48 will be different to that emitted and the difference will correspond to the amount of wear. In a further embodiment, the WMU 48 may be configured with an outward directed light source so as to indicate the current depth 31.

The WMU 48 may further comprise a housing 66 configured to encapsulate the WMU 48 components and circuitry 68 to protect against moisture and/or adverse environmental conditions. In one embodiment, the housing 66 may comprise, for example, an elastic or rubber material that is waterproof. Other materials which may be suitable for appropriately sealing the WMU 48 will be readily known to those skilled in the art.

FIGS. 4A and 4B show a device 10d in accordance with a further embodiment of the present invention. The current embodiment is similar to that shown in FIGS. 3A to 3D; however, the WMU 46 further comprises a communication link (hard wire connection shown) to a transmitter 60 where measured data corresponding to the reflective light received by the light sensor 48 from the reflective portion 19 is transmitted to a controller (not shown) that processes the data so as to monitor amount of wear. The measured data may be transmitted to the controller from the transmitter 60 either wirelessly or via a hard wire connection. Further, the transmission of the data may be via wireless (eg. cellular) or wired communication apparatus for embodiments where the controller resides at a remote location to the wear system 2. It will be appreciated that the measured data may be transmitted to the controller by any effective communication means known in the art.

In one embodiment the light conductive region 20 comprises a void or hollow, typically air-filled.

In a further embodiment, the reflective portion 19 may comprise an optical component of a translucent material that is configured to be a shape substantially complementary to that of the light conductive region 20. The optical component is inserted into the light conductive region 20 in a snug fit or may form the light conductive region 20, or similar. In one embodiment the body 12 may coincide with the light conductive region 20. Use of such a medium to fill the cavity defined by the light conductive region 20 is to inhibit moisture and/or foreign matter, such as dust, ingression into the cavity when the wearable depth 28 gets to a point where the light conductive region 20 becomes exposed. It will be appreciated that any material or medium that is able to reflect light may be used for the reflective portion 19. In a further embodiment, the reflective portion 19 may comprise a material that is injected into the light conductive region 20 and cured over time to a solidified form. The material may be, for example, a clear or translucent resinous compound.

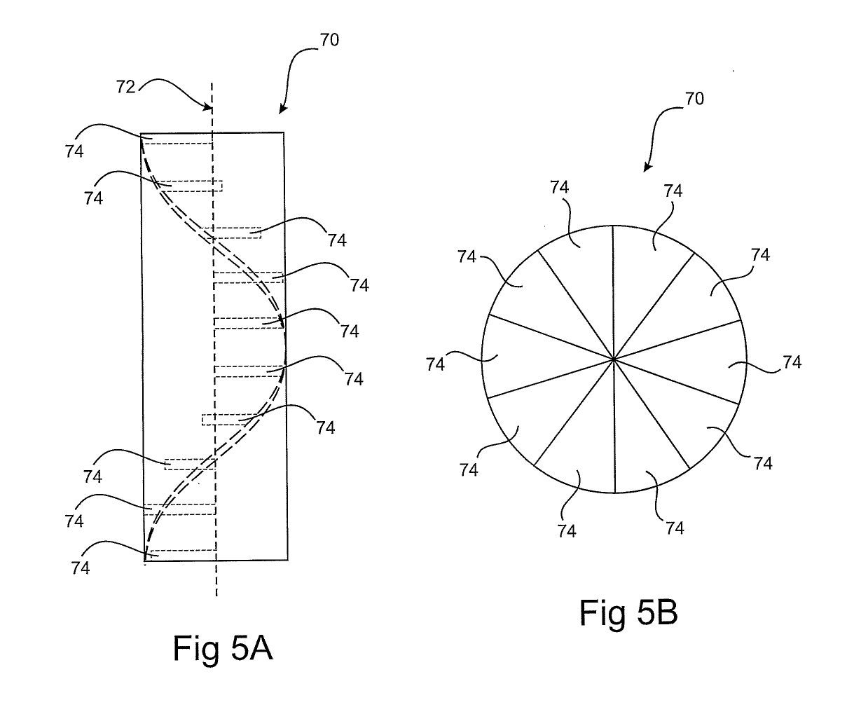

FIG. 5A shows a further embodiment of the reflective portion 19 comprising an optical component 70. The optical component 70 comprises a longitudinal axis 72. Along the longitudinal axis 72 are spaced more than one optical elements each extending radially so as to be perpendicular to the direction of the longitudinal axis 72. In an embodiment the optical elements are reflective elements 74. In the current embodiment, each optical element 74 is configured in the shape of a wedge or pie segment. Each of the reflective elements 74 are rotationally aligned about the longitudinal axis 72 so that light may be reflected through the optical component 70 in a direction that is substantially parallel to the longitudinal axis 72. The elements 74 in combination form a composite reflector that will vary in reflective area as elements are added or removed along the length of the component. The magnitude of the reflected light or change of the reflectance thereof, is a function of physical wear or degradation of the optical component 70 occurring in a direction that is substantially aligned with the longitudinal axis 72 or length of the optical component 70. Wear of the optical component 70 will alter the light reflectance capability as the reflective elements 74 are each physically altered, removed or destroyed by wear.

It will be readily appreciated that the current embodiment of the optical component 70 may be used in the embodiment of devices 10a-10d as hereinbefore described. The physical realisation of the embodiment of the optical component 70 described above may be illustrated where the light conductive region 20 is configured without a taper and the optical component 70 is inserted into the light conductive region 20. Subsequently, the light conductive region 20, with the optical component 70, may be filled with a resinous substance to provide for the integrity of the optical component 70.

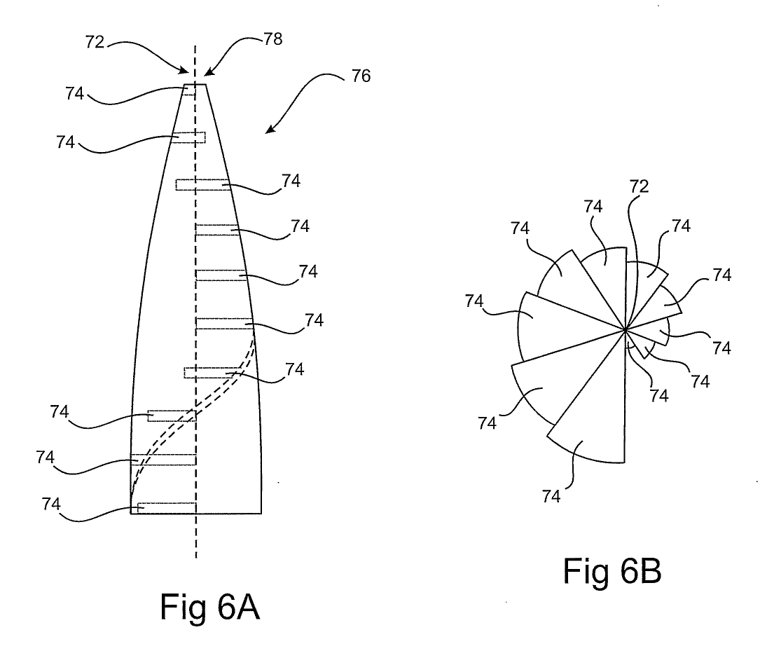

Generally, the widest dimension of the optical component 70 is of uniform along the length as shown in FIG. 5A. FIGS. 6A and 6B show a further embodiment of an optical component 70 where the cross-sectional area varies along the longitudinal axis 72, such as, for example, to establish a tapered region 76 toward a distal end 78 that may coincide and complement the tapered region 30 when inserted therein. It will be appreciated that this embodiment of the optical component 70 may be used with any of the embodiments of the present invention shown in FIGS. 1A and 1B, 3A to 3D or 4A and 4B.

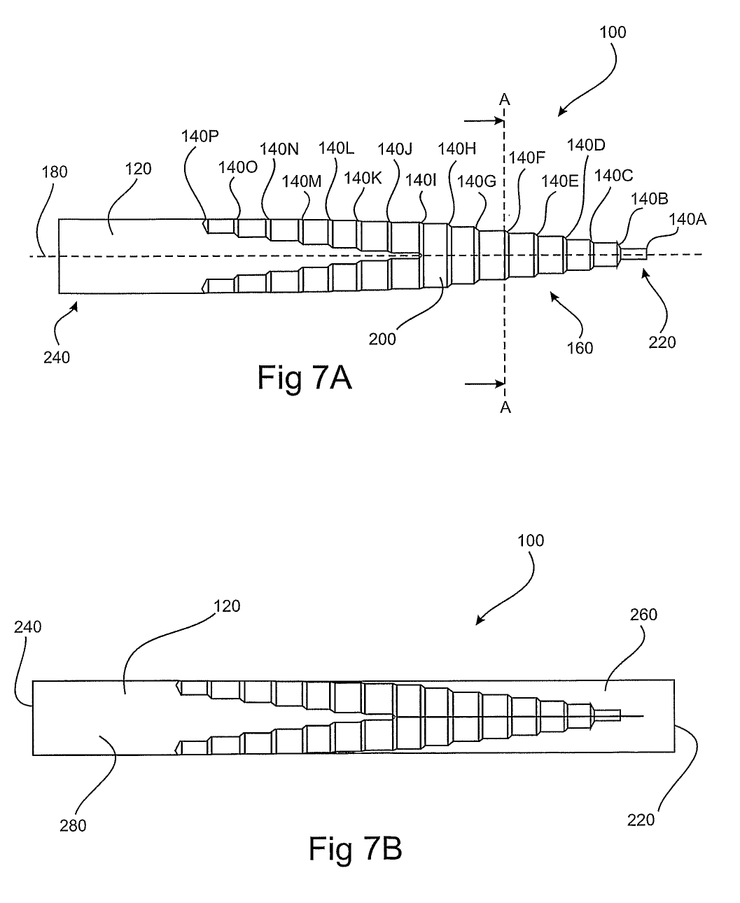

Referring to FIG. 7A, there is shown another example of an optical component 100 comprising an optically transmissible elongate body 120 having a reflective portion 160 comprising a plurality of reflective elements 140a-p (collectively ‘reflective elements 140 ’) positioned along a longitudinal axis 180 of the elongate body 120. The reflective elements 140 may be spaced from each other along the longitudinal axis 180. The reflective portion 160 is profiled in shape so as to orientate the reflective elements 140 to receive light from and to reflect light towards a first end 240.

At least one of the reflective elements 140 may be arranged to extend at least partially circumferentially or axially about the elongate body 120. While sixteen reflective elements 140a-p are shown in this example, another number can be used. At least one of the reflective elements 140 may be frustoconical, or partly frustoconical in shape. The conical shape may be circular in cross section or a polygon in cross section. Alternatively at least one of the reflective elements 140 may be frusto-pyramidal in shape.

The reflective elements 140 may be hollowed shapes, where the diameter of each hollowed shape differs from the others. The hollowed shapes may be non-overlapping. The diameter of the hollow of one shape may be substantially the same as an outer diameter of an adjacent hollowed shape. The reflective elements 140 may be concentric. In this embodiment a portion of the elongate body 120 extends through each hollow of elements 140b-140p. In this way the reflective elements 140 in this embodiment are progressively radially positioned.

In this example, the reflective portion 160 is generally tapered so as to narrow towards a second end 220. Each reflective element 140 is positioned at a discrete location along the longitudinal axis 160. A respective spacing segment 200 of the reflective portion 160 is positioned between each pair of adjacent reflective elements 140, for example between reflective elements 140h and 140i. The combination of the reflective elements 140, their orientations and the spacing segments 200 may result in the general taper being stepped such that each spacing segment 200 forms a flat of each step and each reflective element 140 forms a rise of each step.

The elongate body 120 comprises a substantially transparent material, such as a clear plastic. The reflective elements 140 may comprise any suitable reflective surface, for example a silvered layer, a white layer, or may rely on total internal reflection. Other colours may be used. Each reflective element 140 may be individually coloured or shaded.

In an embodiment the reflective surface of each reflective element 140 is orientated to be substantially perpendicular to the longitudinal axis 180. In this way, light received from the first end 240 can be reflected directly back towards the first end 240. Alternatively, opposite portions of the reflective surface of each reflective element 140 are angled at approximately 45° to the longitudinal axis. In this arrangement, incoming light from the first end 240 will be reflected from a first angled portion of the reflective element 140 towards a corresponding second angled portion opposite the first portion, where the light is then reflected back towards the first end 240. It is further envisaged that the reflective surface of each reflective element 140 may be arranged at other angles so as to direct light entering the first end 240 back towards the first end 240.

FIG. 7B shows the optical component 100 further comprising an opaque portion 260 comprising opaque material such as, for example, white plastic. The opaque portion 260 is arranged on the opposite side of the reflective elements 140 relative to the second end 240. The interface to the opaque portion 260 may act as the reflective surface. In an embodiment a diameter of the opaque portion is the same as a diameter of an end portion 280 of the optical component 100. In an embodiment the optical component 100 is of constant diameter along its length. The reflective elements 140 may form a boundary between the reflective portion 160 and the opaque portion 260.

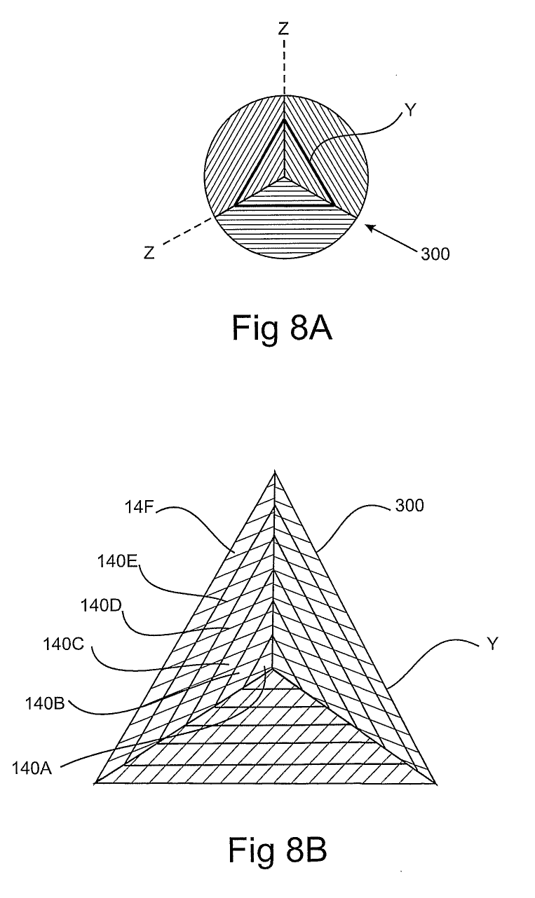

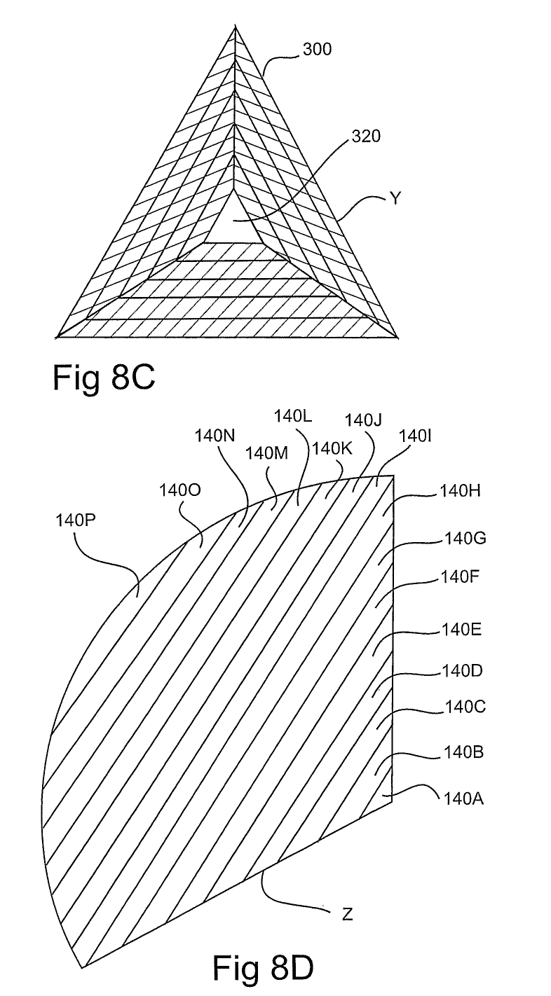

As shown in FIG. 8A, when the optical component 100 is viewed along the longitudinal axis 180, the reflective elements 140 form a composite cross-sectional reflective area 300. A region Y of the reflective area 300, shown in more detail in FIG. 8B, corresponds to a cross-section A-A as marked on FIG. 7A. Each of the reflective elements 140 is positioned to form a respective rise of a step which, as can be seen, forms part of the reflective area 300. In this example, a first reflective element 140a located at the second end 220 corresponds to the centre-most region of the reflective area 300. Each reflective element 140 that is successively closer to the first end 240 of the optical component 100 corresponds to each successive part of the reflective region 300 extending radially outwardly from the central most region of the reflective area 300. In FIG. 8B, the parts in the region Y of the reflective area 300 correspond to each of the reflective elements 140a-f as shown in FIG. 7A.

FIG. 8D shows a partial cross-sectional view of the optical element 100 shown in FIG. 8A. The cross-sectional area shown in FIG. 8D corresponds to region Z-Z as shown in FIG. 8A. Each of the reflective elements 140a-p making up the reflective area 30 are shown in FIG. 8D.

In this embodiment the reflective elements 140a-h are a polygon in cross section and in particular triangular in cross-section. One side of each triangle is shown in FIG. 8D. Reflective elements 140i-140p each comprise three frustoconical or frusto-pyramidal parts symmetrically arranged around the axis 180, although they need not take this form. The number of frustoconical/frusto-pyramidal parts may be different to three, they may be annulus parts, arcuate, or another shape and they need not be symmetrical. The parts may be straight. Alternatively, the reflective elements 140 may be arranged to extend arcuately about the elongate body 120. One of each frustoconical/frusto-pyramidal part is shown in FIG. 8D. The parts may be another suitable shape.

When light is directed into the first end 240 of the elongate body 120, the light propagates through the elongate body 120 and becomes incident on the reflective elements 140. At least some of the incident light will be reflected back towards the first end 240 by the reflective elements 140 (which are present). In this example, the reflective area 300 progressively covers the cross sectional area of the optical component 100.

If the optical component 100 is worn away at the second end 220, the reflective element 140a will be removed. As shown in FIG. 8C, the removal of reflective element 140a creates an aperture 320 in the reflective area 300. If the optical component 100 is subjected to further wear at the second end 220, further reflective elements 140 will be progressively removed. As more wear occurs and subsequent reflective elements 140 are worn away, the aperture 320 will dilate radially outwardly from the centre of the reflective area 300 as a function of the amount of wear applied to the second end 220. Accordingly, the amount of dilation will change, which in turn will mean that light that can be reflected by the reflective area 300 will be reduced as the optical component 100 is worn away from the second end 220.

When light is directed into the first end 240 of the optical component 100, a measurement of the amount of light reflected towards the first end 240 can then be used to gauge the amount of wear that the reflective portion 160 has been subjected to. Alternatively measuring the amount of dilation of the aperture can be used to gauge the amount of wear. As a further alternative, when the reflective elements 140 are of differing colours, measuring the change in colour reflected can be used to gauge the amount of wear.

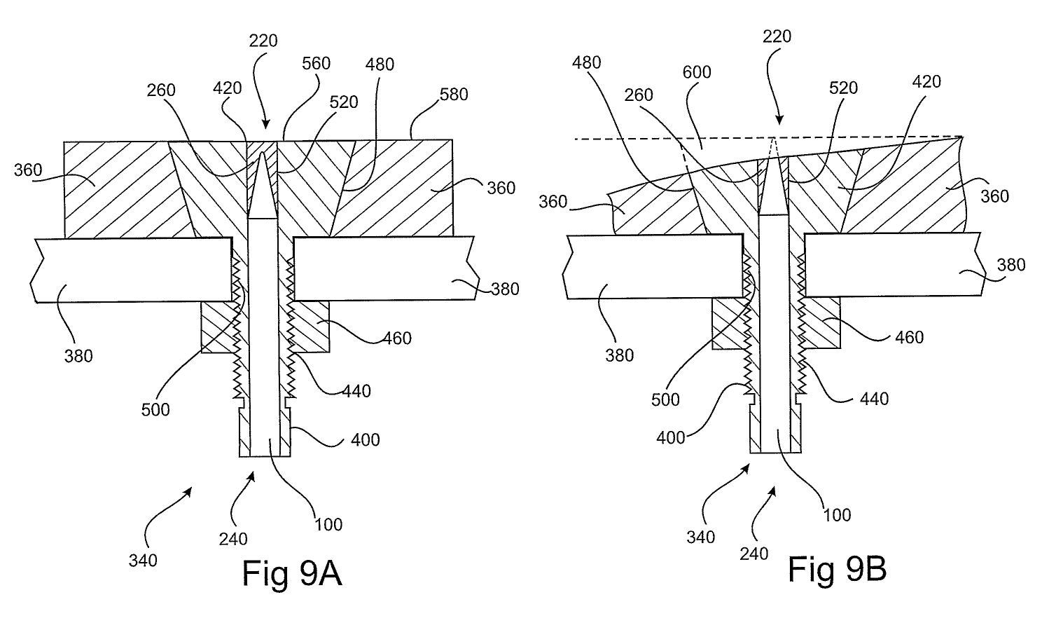

As shown in FIGS. 9A and 9B, the optical component 100 can be used as part of a wear sensor 340. The wear sensor 340 can be used to measure the amount of wear that an object has been subjected to. In this example, the wear sensor 340 is used to measure the amount of wear that a wear plate 360 has been subjected to similar to the device 10a-10d described above. The wear sensor 340 may be used in other applications. The wear plate 360 is being used to protect a structural element 320. In this example the wear plate 360 may be fastened to the structural element 380 by the wear sensor 340. The wear sensor 340 comprises a fastener having a body 400 (in the form of a bolt), having a head 420 and a shank 440 similar to that described above. The shank 440 may have an external thread for receiving a retaining nut 460 (shown in FIGS. 9A and 9B). The head 420 sits in a complementary frusto-conical hole 480 in the wear plate 360. The shank 440 passes through a hole 500 in the structural element 380. The head 420 has a straight bored hole 520 in which an optical component 100 sits. The region in the hole 520 adjacent the first end 220 of the optical component 100 is back filled with an opaque material to form the opaque portion 260. In this way, the opaque portion 260 is positioned on an opposite side of the reflective elements 140 relative to the first end 240 into which light may be directed. The head 420 and retaining nut 460 may co-operatively fasten the wear plate 360 to the structural element 380 as described above.

It will be appreciated that other fasteners known in the art could be used, including traditional bolts. In the current embodiment, the top surface 560 of the head 420 remains co-planar with the outer surface 580 of the wear plate 360. The wear sensor 340 is configured to receive the optical component 100 within the shank 440 and extends from the first end 240 to substantially the surface 560 (FIG. 9A) at the second end 220 of the body 120.

The current embodiment of the wear sensor 340 is shown in FIG. 9B with a portion of the wear sensor 340 at the second end 220 having been worn down to a depth 600 in accordance with wear experienced by the adjacent wear plate 360.

As the wear sensor 340 is worn away at the second end 220, the optical component 100 will be worn away from the second end 220 and the reflective elements 140 will be progressively removed. Accordingly, if light is directed into the first end 240 of the wear sensor 340, less light will be reflected back towards the first end 240 as more wear occurs.

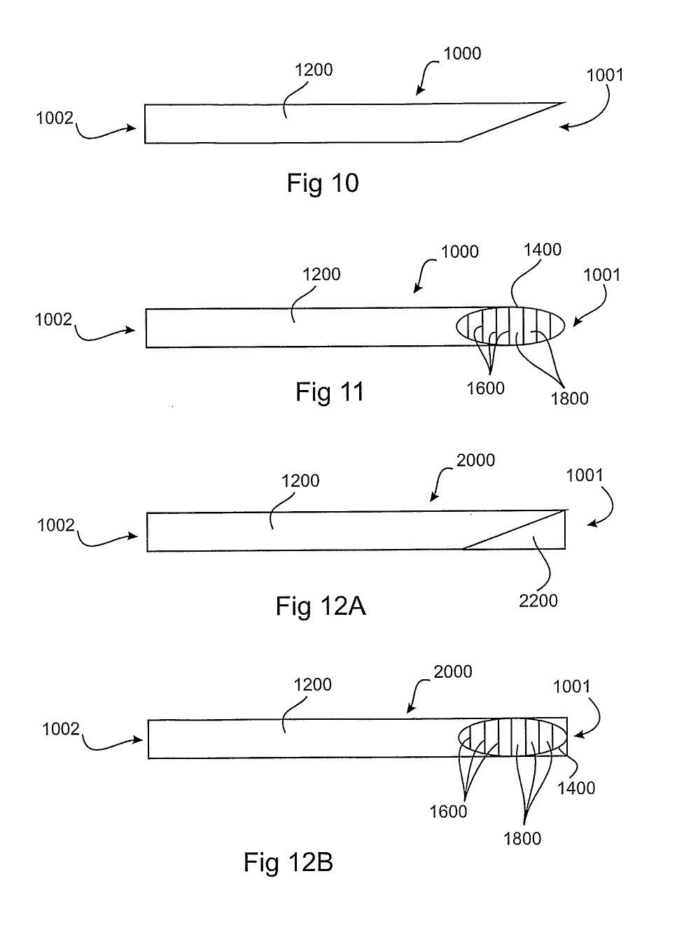

FIGS. 10A and 11B show another example of an optical component 1000 comprising an optically transmissible elongate body 1200 having a marking region 1400 towards a first end 1001 thereof. As shown more clearly in FIG. 11B, the marking region 1400 comprises a plurality of markings 1600 spaced apart by spacings 1800. The markings 1600 may comprise opaque black lines or bars. The spacings 1800 may comprise a transparent plastics material or, for example, a white opaque material. Many variations of the markings 1600 and spacings 1800 are envisaged, however the underlying concept is that the markings 1600 are differentiable from the spacings 1800, for example by being of different or contrasting colours from one another.

In this example, the markings 1600 are arranged to be substantially transverse to the length of the elongate body 1200 and accordingly are spaced apart in a direction along the length of the elongate body 1200. In this example, the first end 1001 has an oblique profile so that the marking region 1400 extends across and along a length of the elongate body 1200. Due to this arrangement, each of the markings 1600 can be viewed from a second end 1002 of the elongate body 1200.

FIGS. 12A and 12B show another embodiment of an optical component 2000 with an opaque portion 2200 arranged on the opposite side of the marking region 1400 relative to the second end 1002. In this example, the opaque portion 2200 acts as a contrasting background to the markings 1600 and may comprise a white opaque plastic. In this arrangement, if the spacings 1800 comprise a clear plastics material, the markings 1600 will be contrasted against the white opaque portion 2200 which will be visible from the second end 1002.

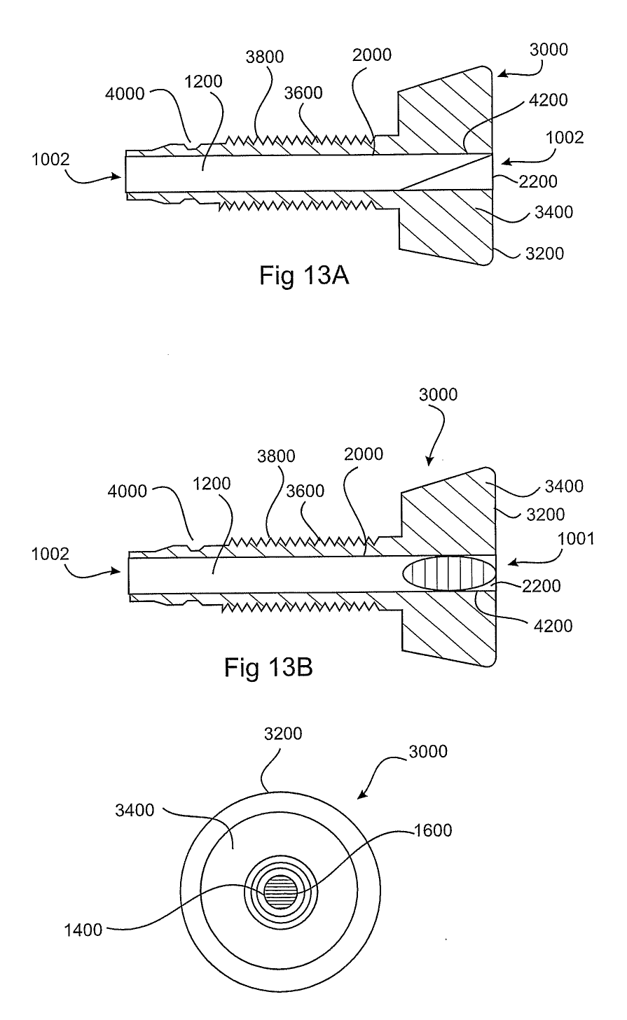

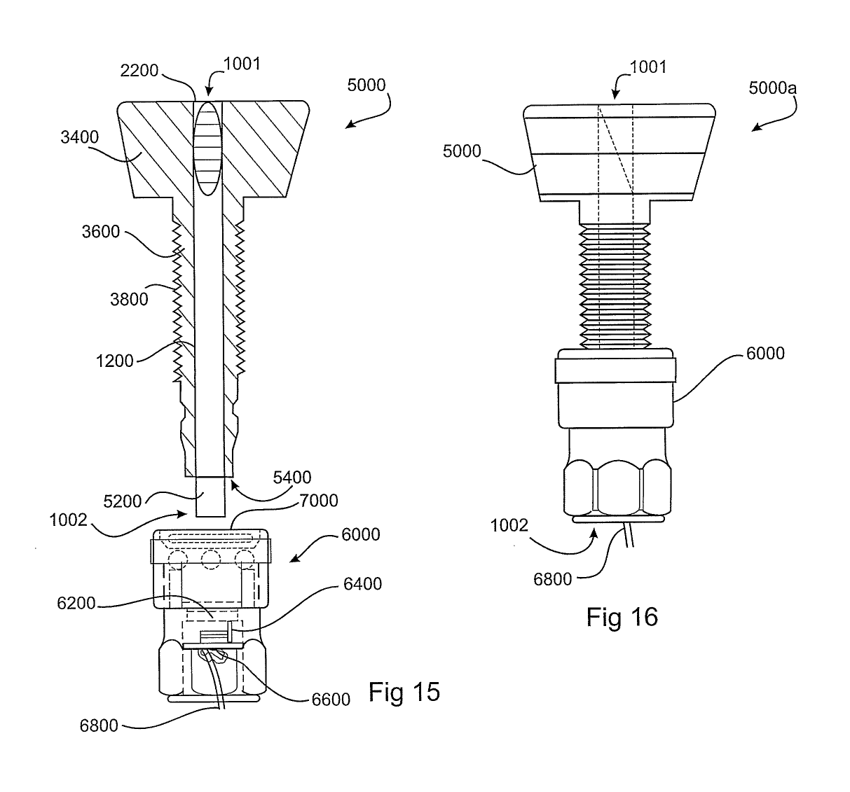

FIGS. 13A and 13B show a wear sensor 3000. In this example the optical component 2000 has been incorporated into a fastener 3200. The fastener 3200 comprises a head 3400 and a shank 3600. The shank 3600 may further comprise an external thread 3800 and an indentation 4000 for use in securing a device for assessing the number of markings 1600. An example of such a device (scanning device 6000 shown in FIG. 15) is described with reference to FIG. 15 later.

FIG. 14 shows an end view of the wear sensor 3000 as viewed from the second end of FIG. 13A or 13B. From this view it becomes apparent that the marking region 1400 can be viewed through the wear sensor 3000 and the markings 1600 can accordingly be viewed. In this example, as the first end 1001 of the wear sensor 3000 is worn away, the marking region 1400 is also worn away resulting in the markings 1600 being successively removed. When viewing the wear sensor 3000 from the second end 1002 as shown in FIG. 14, the number of remaining markings 1600 that are visible will reduce as the extent of wear increases. This allows the extent of wear to be gauged as the number of remaining markings is related to the amount of wear that has been caused to the wear sensor.

When gauging the amount of wear caused to the wear sensor 3000, the number of markings 1600 can be counted by sight. Alternatively, the number of markings 1600 can be counted using a device arranged to count the number of markings 1600 automatically, for example by means of a scanning device arranged to direct light towards the first end 1001 and measuring the amount of reflected light at the second end 1002. As a further alternative, an indication of the number of markings 1600 that remain, and therefore the amount of wear the wear sensor 3000 has been subjected to, can be obtained by comparing the amount of light reflected from the first end 1001 before wear has occurred to the sensor 3000 to the amount of light reflected light after the wear sensor 3000 has been subjected to wear.

Referring now to FIG. 15 there is shown an embodiment of a wear sensor 5000 comprising a scanning device 6000 which can be used as an alternative to manually counting the number of markings 1600 remaining. In this particular example, the wear sensor 5000 comprises a protrusion 5200 arranged at the second end 1002, the protrusion 5200 being shaped to be received by a complementary shaped opening 7000 of the scanning device 6000. In having a complementary shaped opening in the scanning device 6000, the scanning device 6000 and the wear sensor 5000 can be aligned correctly, for example by ensuring the markings 1600 are aligned with and correctly oriented in relation to a light source/receiver 6600. In this example, the protrusion 5200 comprises a void 5400 that receives a complementary shaped pin 6400 disposed in the opening 7000.

As shown in FIG. 16, the scanning device 6000 and the wear sensor 5000 can be combined to form a wear sensor 5000a. Wear sensor 5000a can be used with an object to measure the extent of wear the object has been subjected to. If the wear sensor 5000a is incorporated into an object so that the first end 1001 (corresponding to the end adjacent the marking region 1400) is coplanar with the end of the object that is being subjected to wear, then the extent of wear measured by the wear sensor 5000a will correspond to the extent of wear caused to the object itself.

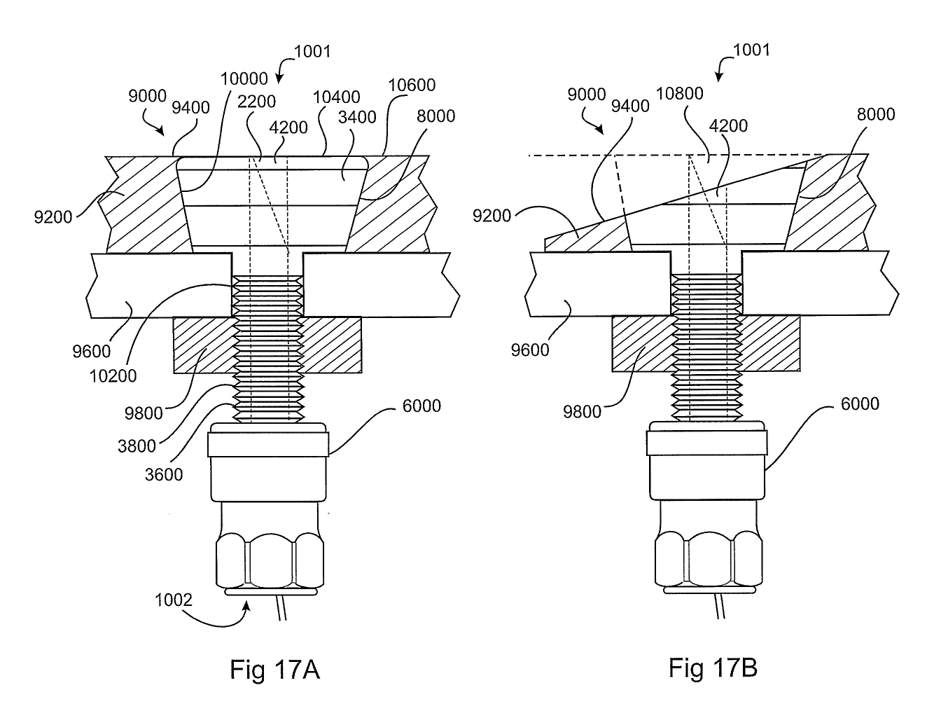

As shown in FIGS. 17A and 17B, the wear sensor 5000a can be used to measure the amount of wear an object has been subjected to. In this example the wear sensor 5000a is used to measure the amount of wear that a wear plate 9200 has been subjected to. It is also envisaged that the wear sensor 5000a can be used in other applications where it is desirable to measure the amount of wear that an object undergoes. In this example, the wear plate 9200 is being used to protect a structural element 9600. The wear plate 9200 is fastened to the structural element 9600 by the wear sensor 5000a itself, the wear sensor 5000a comprising a fastener 3200 having a head 3400 and a shank 3600. The shank 3600 has an external thread 3800 for receiving a retaining nut 9600. The head 3400 sits in a complementary frustoconical hole 10000 in the wear plate 9200. The shank 3600 passes through a hole 10200 in the structural element 9600. The head 3400 has a straight bored hole 4200 in which the optical component 2000 sits. The region of the hole 42 adjacent the first end 1001 is back filled with an opaque material to form the opaque portion 2200. In this way, the opaque portion 2200 is positioned on an opposite side of the marking region 1400 relative to the scanning device 6000. The head 3400 and the retaining nut 9800 co-operatively fasten the wear plate 9200 to the structural element 9600.

In the current embodiment the top surface 10400 of the head 3400 remains co-planer with the outer surface 10600 of the wear plate 9200. The wear sensor 5000a is configured to receive the optical component 2000 within the shank 3600 and extends from the end adjacent the scanning device 6000 to substantially the surface 10400.

The current embodiment of the wear sensor 5000a is shown in FIG. 17B with a portion of the first end 1001 of the wear sensor 5000a having been worn down to a depth 10800 in accordance with wear experienced by the adjacent wear plate 9200. As the wear sensor 5000a is worn away at the first end 1001, the optical component 2000 will be worn from the same end and the markings 1600 will be progressively removed. Accordingly, if light is directed towards the marking region 1400 of the wear sensor 5000a, fewer markings 1600 will be detected as more wear occurs.

The scanning device 6000 demonstrates one example of how to assess the number of remaining markings 1600. The light source/receiving element 6600 may direct light towards the marking region 1400 and continuously take measurements of the reflected light so as to determine the number of markings 1600 remaining. When operable, the light source/receiving element 6600 generates light that propagates through the optical component 2000 towards the marking region 1400 of the elongate body 1200. The markings 1600 in this example are configured so as to absorb at least a portion of the light directed theretowards. The reflected light is measured by the light source/sensing element 6600. The reflected light impinging on the light source/sensing element 6600 is converted by a device such as a photodiode to produce a signal used to determine the number of markings 1600 that remain.

As wear occurs and the depth 10800 of wear develops and increases as shown FIG. 17B, the end adjacent the marking region 1400 of optical component 1000 will begin to be worn also resulting in the progressive removal of the markings 1600. Consequently, the number of markings 1600 detected by the scanning device 6000 will reduce as more wear occurs.

The scanning device 6000 may further comprise a communication link 6800 to a transmitter (not shown) where measured data corresponding to the reflected light received by the light source/receiving element 6600 from the marking region 1400 is transmitted to a controller (not shown) that processes the data so as to monitor the amount of wear as described above.

It may be appreciated that an array of devices for measuring wear according to any of the embodiments described herein of the present invention may be deployed on the wear plate system 2. Accordingly, it then becomes possible to map out the extent of wear of the wear plates 4 without the need to remove them for inspection or the need to rely on rule of thumb methods. Thus, plates that need changing can be changed at the most appropriate time.

It will be appreciated that with any of the embodiments described, surface 16 of the body 12 may be configured with suitable recesses that may allow the body 12 to be threaded or located the body 12 into position. For example, there may be recess(es) forged into surface 16 to allow a tool to be inserted so as to permit the body 12 to suitably rotate and therefore engage a complementary thread for secure location.

In FIG. 2, a wear monitoring system 900 is shown for monitoring the wear plate system 2. The wear plate system 2 is installed on a piece of equipment subject to wear, such as for example a chute or a hopper. In this example each wear plate 4 has a set of four holes 6 in which a fastener is used to secure the wear plate 4 in position, or a probe, which does not have a fastening role, may be used. Each fastener has a wear sensor 10, such as those described above installed, so that, in this example, each wear plate 4 has four sensors each monitoring the extent of wear to the respective wear plate 4. Another number of sensors per wear plate may be used.

The wear sensors 10 are periodically read to produce a data steam 902 reflecting the depth of wear at each point, which is stored in a data storage device, such as a mass storage device 908 of a computer 904. The data stream 902 is processed by the computer 904 to monitor the extent of wear occurring to individual wear plates 4 in the hopper. The computer 904 may be configured to operate as the controller described above, such that if the level of wear to a plate reaches a threshold value, then it triggers an alert to be generated. The alert may be shown on a display 906 or output to another system, such as a message system that triggers scheduling of maintenance of the hopper so that the worn plate can be replaced at a convenient time prior to failure.

The computer 904 may be configured to show on the display 906 a representation of the depth of wear to the wear plates 4 in a graphical form, such as in the form of a graph of the remaining thickness of the wear plates 4 along a line. The location of the line may be selectable. For example, graph X-X shows the thickness along the line X-X and graph Y-Y shows the thickness along line Y-Y. As shown certain plates may be more worn than others. The wear monitoring system 900 allows the extent of wear to be tracked so that worn plates can be replaced at a convenient time prior to failure.

The computer 904 may be configured to calculate an estimate time of wear plate replacement, based on a calculated rate of wear which is calculated from monitoring the extent of wear of each plate over time.

Typically the computer 904 will be configured by loading instructions, in the form of a computer program, from the mass storage device into working memory.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description.

1-44. (canceled)

45. A device for measuring wear comprising:
an optical component having a first end subject to wear and a second distant end, the optical component comprising a reflector extending in a direction of wear of the component from the first end toward the second end, with the reflector capable of reflecting light propagating from the second end towards the first end back to the second end and being arranged wherein an amount of light reflected by the reflector varies as a function of depth of wear of the reflector in the direction of wear.

46. The device according to claim 45, wherein the reflector has a reflective area that extends for a length of the reflector in the direction of wear, and wherein as the reflector wears, the reflective area varies.

47. The device according to claim 46, wherein the reflector is configured such that as the reflector initially wears an aperture is created in the reflective area and wherein the aperture increases in size as wear of the reflector progresses in the direction of wear.

48. The device according to claim 46, wherein the reflector comprises a plurality of reflective elements which together form the reflective area of the reflector, with the reflective elements configured to sequentially wear away as the reflective wears.

49. The device according to claim 48, wherein the reflective elements extend transversely from a longitudinal axis of the optical component and wherein the longitudinal axis coincides with the direction of wear.

50. The device according to claim 48, wherein the reflective elements extend transversely from and are axially spaced along a longitudinal axis of the optical component and wherein the longitudinal axis coincides with the direction of wear.

51. The device according to claim 45, wherein the reflector comprises a plurality of spaced apart markings, the markings being visible from the second end of the optical component, and the markings further being arranged so as to be successively worn away as the reflector wears in the direction of wear.

52. The device according to claim 45, wherein the reflector comprises a plurality of reflective elements positioned along a longitudinal axis of the optical component, with each reflective element having a face extending in a spaced relationship with the longitudinal axis, and with the reflective elements together forming a composite cross-sectional reflective area;
wherein an aperture in the composite cross-sectional reflective area dilates as the reflector wears in the direction of wear.

53. The device according to claim 45, wherein the reflector comprises a plurality of longitudinally spaced hollowed reflective elements of differing diameter, with the reflective elements arranged to be progressively removed with wear of the reflector in the direction of wear.

54. The device according to claim 53, wherein the hollowed reflective elements are non-overlapping.

55. The device according to claim 54, wherein a diameter of the hollowed portion of one reflective element is substantially the same as an outer diameter of an adjacent reflective element.

56. The device according to claim 45, wherein the reflector comprises a reflective surface formed on an inside surface of a hole which extends in the direction of wear.

57. The device according to claim 56, wherein the optical component comprises a transparent or translucent material disposed in the hole.

58. A wear sensing fastener capable of fastening a body, having a surface subject to wear, to a structure, the fastener comprising:
a head arranged to wear at a same rate as the wear surface and configured to engage a hole formed in the body and to lie substantially flush with the wear surface;
a shank coupled with the head, the fastener being provided with an axial passage that extends axially thought the shank and into the head in a direction of wear of the wear surface; and,
an optical component having a first end subject to wear and a second distant end, with the optical component disposed in the passage and comprising a reflector extending in the direction of wear with at least a portion of the first end of the reflector located in a portion of the passage in the head, and with the reflector capable of reflecting light propagating from the second end towards the first end back to the second end and being arranged wherein an amount of light reflected by the reflector varies as a function of depth of wear of the reflector in the direction of wear.

59. The fastener according to claim 58, wherein the reflector has a reflective area that extends for a length of the reflector in the direction of wear, and wherein as the reflector wears, the reflective area varies.

60. The fastener according to claim 59, wherein the reflector is configured such that as the reflector initially wears, an aperture is created in the reflective area and wherein the aperture increases in size as wear of the reflector progresses in the direction of wear.

61. The fastener according to claim 59, wherein the reflector comprises a plurality of reflective elements which together form the reflective area of the reflector, with the reflective elements configured to sequentially wear away as the reflective wears.

62. The fastener according to 61, wherein the reflective elements extend transversely from a longitudinal axis of the optical component wherein the longitudinal axis coincides with the direction of wear.

63. The device according to claim 61, wherein the reflective elements extend transversely from and are axially spaced along a longitudinal axis of the optical component and wherein the longitudinal axis coincides with the direction of wear.

64. The fastener according to claim 58, wherein the reflector comprises a plurality of spaced apart markings, the markings being visible from the second end of the optical component, with the markings further being arranged so as to be successively worn away as the reflector wears in the direction of wear.

65. The fastener according to claim 58, wherein the reflector comprises a plurality of reflective elements positioned along a longitudinal axis of the optical component, with each reflective element having a face extending in a spaced relationship with the longitudinal axis, and with the reflective elements together forming a composite cross-sectional reflective area;
wherein an aperture in the composite cross-sectional reflective area dilates as the reflector wears in the direction of wear.
